(19) United States
(12) Patent Application Publication
(10) Pub. No.: US 2016/0170725 A1
(43) Pub. Date: Jun. 16, 2016

(54) GLOBAL CALL CONTROL FLOW GRAPH FOR OPTIMIZING SOFTWARE MANAGED MANYCORE ARCHITECTURES

(71) Applicants: Bryce Holton, Phoenix, AZ (US); Aviral Shrivastava, Phoenix, AZ (US); Ke Bai, Sunnyvale, CA (US)

(72) Inventors: Bryce Holton, Phoenix, AZ (US); Aviral Shrivastava, Phoenix, AZ (US); Ke Bai, Sunnyvale, CA (US)

(73) Assignee: ARIZONA BOARD OF REGENTS ON BEHALF OF ARIZONA STATE UNIVERSITY, Scottsdale, AZ (US)

(21) Appl. No.: 14/969,437

(22) Filed: Dec. 15, 2015

Related U.S. Application Data
(60) Provisional application No. 62/092,079, filed on Dec. 15, 2014.

(51) Int. Cl. G06F 9/45

(52) U.S. Cl. CPC G06F 8/433; G06F 8/443

(57) ABSTRACT

Software Managed Manycore (SMM) architectures with scratch pad memory for reach core are a promising solution for scaling memory. In these architectures the code and data of the tasks mapped to the cores is explicitly managed by the compiler and often require inter-procedural information and analysis. But, a call graph of the program does not have enough information, and the Global CFG has too much information. Most new techniques informally define and use GCCFG (Global Call Control Flow Graph)—a whole program representation that succinctly captures the control-flow and function call information—to perform inter-procedural analysis. Constructing GCCFGs for several cases in common applications. The present disclosure provides unique graph transformations to formally and correctly construct GCCFGs for optimal compiler management of manycore systems.

### CROSS-REFERENCE TO RELATED APPLICATIONS

This application claims priority to U.S. Provisional Application No. 62/092,079 filed Dec. 15, 2014, which is specifically incorporated herein by reference without disclaimer.

### STATEMENT REGARDING FEDERALLY SPONSORED RESEARCH AND DEVELOPMENT

The invention was made with government support under Grant No. 0916652 awarded by the National Science Foundation. The government has certain rights in the invention.

### BACKGROUND OF THE INVENTION

1. Field of the Invention

The present invention relates generally to the field of hardware architecture data management. More particularly, it concerns optimization of Software-Managed Manycore (SMM) Architectures.

2. Description of Related Art

When programs run on a computer or other electronic device, computer code is compiled from programming languages down to machine level commands and binary code that are execute on hardware. A computer program consists of many functions and, each function may contain many lines of code that are executed when it is called by a program or by another function. In complicated code that supports user inputs and variable branch operations, large amounts of code are produced that might not need to execute on hardware. For example, many lines of code may be present to support doing Y if the user does action X while also supporting performing B when the user does action A. In this basic example, if the user never performs action A, then the code for performing B is not necessary. The compiler that translates computer code is responsible for recognizing this and ensures that the superfluous code does not waste any processing resources. Compilers are also tasked with maximizing efficiencies, like recognizing patterns that may be performed in fewer steps and controlling the flow of data and programs to efficiently utilize hardware resources.

Manycore systems provide a unique challenge for efficient code handling In these systems, software—via the compiler and other applications—controls program process flow and manages hardware resources. When running applications on a manycore system, different portions of an application or program must be tasked to different portions of the system to maintain optimal utilization of each core in the manycore system. One benefit of manycore systems is that they maintain local Scratch Pad Memory (SPM) for each of the cores. This reduces latency for each core that otherwise exists when relying on memory fetches from distant or global memory. SPM may be effectively utilized by managing which portions of an application are saved to each portion of SPM and its corresponding cores. This application management requires a detailed understanding of how a given application flows, including information about function calls, loops, switches, and conditional statements. The prior art describes several solutions for mapping application flow and structure to be used in software management of multicore and manycore systems; however, these solutions often provide either too little or too much information about an application's structure. Too little information limits how well SPM and the processing cores in the system are utilized. Too much information about application structure bogs down SPM and limits efficiency gains in a software managed system.

For example, Control Flow Graphs (CFGs) have been a long-used and essential tool in recognizing potential compiler efficiencies. CFGs represent code and process flow to facilitate creating compiler algorithms that remove “dead code” and implement efficiencies where certain code or patterns are recognized. Compilers use CFGs to transform or run code more efficiently Efficient program management becomes increasingly complex with many core processors, which are the leading edge in computer architectures. To maximize utilization of each core, the compiler must have a succinct yet complete view of a program's flow so that individual functions along with the appropriate memory allocations may be mapped to cores without being limited by the program or function flow.

Scaling the memory architecture in software managed systems is a major challenge when transitioning from a few cores to many core processors. Experts believe that coherent cache architectures will not scale to hundreds and thousands of cores (Heinrich, et al., 1999; Bournoutian & Orailoglu, 2011; Choi, et al., 2011; Xu, et al., 2011), not only because the hardware overheads of providing coherency increases rapidly with core count, but also because caches consume a lot of power. One promising option for a more power-efficient and scalable memory hierarchy is to use raw, “uncached” memory (commonly known as Scratch Pad Memory or SPM) in the cores. Since SPM does not have the hardware for address lookup and translation, they occupy 30% less area, and consume 30% less power than a direct mapped cache of the same effective capacity (Banakar, et al., 2002). In these types of systems, the coherence of memory addressing has to be provided in the software so that hardware is more power-efficient and scalable. A multicore/manycore architecture in which each core has an SPM instead of hardware caches is called a Software Managed Multicore (SMM) architecture (Bai, et al., 2013; Lu, et al., 2013). The Cell processor (Flachs, et al., 2006) (used in PlayStation 3) is a good example of an SMM architecture. Thanks to the SMM architecture, the peak power-efficiency of the Cell processor is 5 GFlops per Watt (Flachs, et al., 2006). Contrast this to the Intel i7 4-core Bloomfield 965 XE with power-efficiency of 0.5 GFlops per Watt (“Raw Performance . . . ” 2010; “Intel Core . . . ” 2010), both fabricated in the 65 nm technology node.

The main challenge in the SMM architecture is that several tasks like data management (movement of data between SPMs of the cores and the main memory) and inter-core communication (movement of data between the SPMs of cores), which were originally done by the hardware (more specifically, the cache hierarchy) now have to be explicitly done in the software, and that may cause overheads. Recent research results have been quite encouraging. Techniques have been proposed to manage all kinds of data: code (Bai, et al., 2013; Jung, et al., 2010), stack (Lu, et al., 2013; Bai, et al., 2011), and heap (Bai, et al., 2010; Bai, et al. 2013; Bai, et al., 2011b; Udayakumaran, et al., 2006) efficiently on the SPMs of the core. In fact, Bai, et al., 2013 and Lu, et al., 2013 show that the overhead of code and stack management on SPMs is lower than on a cache based architecture. Thus SMMs are coming up as a strong contender for processor architecture in the manycore era. All the state-of-the-art data management techniques that have been developed to date for SMM architectures are inter-procedural code transformations and require extensive inter-procedural analysis. One of the fundamental challenges is finding the right representation of a whole program, such that it captures the required information, and yet is not too big and cumbersome. For example, the call graph of a program depicts which functions call other functions, but it does not contain information about the loops and if-then-elses present in the programor within the functions. Also, it does not contain information about the order in which the functions are called. All this information is vital for the code transformations required for SMM architectures. Control Flow Graph (CFG) contains detailed information of all the control flow, but it is only for a single function. Researchers have tried to stitch together the CFGs of various functions by essentially pasting the CFG of the called function at the site of its call—named Global CFG (Udayakumaran, et al., 2006; Whitham, et al., 2012; Polychronopoulos, 1991). Global CFG is a detailed representation of the whole program, but it grows too big, and discovering the information SMM transformations need from this graph is very time consuming and cumbersome at the least. The prior art lacks a succinct representation of a whole program that contains functional call information, as well as important control flow structures of the program, e.g., loops and if-then-elses.

Previous research on developing code transformations for SMM architectures have used Global Call Control Flow Graph or GCCFG (Baker, et al., 2010; Jung, et al., 2010; Bai, et al., 2013; Lu, et al., 2013). GCCFG is a whole program representation, and is a hybrid between a call graph and control flow graph. GCCFG is a hierarchical representation of the program that abstracts away straight line code, and captures the function call and control flow information of the program. For example, a GCCFG is shown in FIG. 1B of an ordered hierarchical representation of a program shown in FIG. 1A, and consists of three kinds of nodes, function nodes (e.g., 101-106 in FIG. 1B), loop nodes (e.g., 107), and condition nodes (e.g., 108). In the program, function F1 (node 101) calls, in order, functions F2 (node 102) and F3 (node 103). Node 102 is the left child of node 101 and node 103 is the right child of node 101. Positioning of nodes from left to right represents that node 102 precedes node 103. Function F2 in node 102 contains an if-then-else, in which function F4 (node 104) is called in the if-part, and function F5 (node 105) is called in the else part. Function F3 also contains a loop in which function F6 (node 106) is called. Functions F4, F5, and F6 contain only straight line code. Note that the GCCFG abstracts away the straight line code, and only keeps the function call and control flow information in a succinct hierarchical form.

While previous research has informally defined and used GCCFG, they have not shown how to construct it for any given program. While constructing GCCFG for simple programs is relatively straightforward, there are several very commonly found program structures where constructing GCCFG is complicated. For example, loops that have multiple exits (commonly caused by continue, break, goto statements, and loops that return values), and intertwined loops (caused by goto statements), and switch statements, and if-then-else statements with exit statements, etc. GCCFGs have the potential to greatly enhance hardware utilization but the prior art has been incapable of handling these and other complicated cases.

### SUMMARY OF THE INVENTION

The present disclosure defines GCCFGs and shows the construction of GCCFGs in several complicated cases to facilitate the use of GCCFGs for compiler enhancements in SMM architectures. As opposed to Global CFG, GCCFG is a more succinct representation, and results in more efficient implementations of the inter-procedural analysis required for code and stack data management on SMM architectures. Experiments conducted on MiBench benchmarks (Guthaus, et al., 2001) demonstrate that, the compilation time of a state-of-the art code management technique can be improved by an average of 5×, and that of stack management can be improved by 4× through GCCFG as compared to Global CFG.

### The Need for GCCFG's for Code Mapping on SMM Architectures

A. GCCFG's are an optimal code mapping for SMM architectures. In an SMM architecture, a task is mapped to a core, and the core has access to only its local Scratch Pad Memory or SPM. All code and data that the task uses must come from SPM. If the code of the application requires more memory than is available in the SPM, then the whole code can reside in the large global memory and may be brought into SPM with a piecemeal approach. To facilitate this, SMM architecture allows users to divide the code part of the SPM into regions, and functions in the program can be mapped to the regions in the SPM. For example, FIG. 2 illustrates embodiments of the present disclosure where SPM regions e.g., 201-203 may be divided to hold different functions. In some embodiments, functions are mapped from global memory 210 to the various regions 201-203. FIG. 2 illustrates an example of mapping functions from global memory 210 in callouts 220, 230, and 240. In the illustrated embodiment, functions F1 and F5 are mapped to region 201 from global memory 210; functions F2, F3, and F6 are mapped to region 202; and functions F4 and F7 are mapped to region 203. In some embodiments, mapping functions to regions is specified in a linker file and is used at runtime. At runtime, of all the functions mapped to a region, only one can be present in the region at runtime. In some embodiments, when a function is called, it is brought into its region in the SPM, and the existing function is simply overwritten. While any region formation and mapping of functions to regions may be beneficial, if there is only one region, and all the functions map to that region, then there may be a function code replacement at every function call, which may severely hurt performance. Some embodiments with separate region for each function may have better performance because there will be no replacements, but such an embodiment may require a lot more. Thus, optimal code management stems from a division of the SPM code space into regions, and mapping functions to those regions so as to minimize the data transfers between the SPM and the main global memory.

B. Information for optimal code mapping Some embodiments require certain information to solve the optimal code mapping problem. In some embodiments this includes an estimate the amount of data transfers that will happen when two functions are mapped to the same region. For example, in the program shown in FIG. 1A, if F3 and F6 are mapped to the same region, then there will be a lot of replacements, since the function F3 calls F6 in a loop. Each time after the execution returns from F6, the execution comes back to the function F3, therefore it must be brought back into the SPM. On the other hand, it might be better to place the functions F4 and F5 in the same region, since only one of them will be called. Thus, in order to find out which functions can be mapped in the same region, we need information like which function calls another function, and whether a function call happens in a loop (and if so, how many levels of loops), an if-then-else, or just in a straight-line code—collectively called control flow information. GCCFG captures all this information in a succinct manner In fact, the sequence in which the functions, are called in the program, can be derived relatively accurately from the GCCFG. For the given GCCFG, the approximate sequence of function executions is F1-F2-(F4|F5)-F2-F1-(F3; F6)*-F1, where (F4|F5) implies the execution of one of them. Note that after executing F4 or F5, the execution returns to F2 and then to F1, since they are the calling functions.

C. Why a call graph is not enough? The function execution sequence cannot be derived from a call graph. The first problem is that in the call graph, the order in which functions are called is absent. The GCCFG's of the present disclosure preserve the function call order. For example, in some embodiments, the left child of a node is called before the right child. Second, call graphs lose all control flow information, so it is unknown if afunction is being called in a loop, or in an if-then-else, or just in straight-line code. While it is clear that each of these structures has a very significant impact on the sequence of the function executions, and therefore the number of times the function has to be brought into the SPM. In fact, even annotating the call graph with how many times a function is called is not enough. That is because, it still does not capture the context in which the functions are called. For example FIGS. 3B and 3C shows two GCCFGs, 304 and 308, that can be drawn for the same call graph 300. The GCCFGs have very different function call sequences, which ultimately results in a different mapping being optimal for each case. The GCCFG 304 has a function execution sequence of F1-(F2-F1-F3-F1)¹⁰, while GCCFG 308 has a function execution sequence of F1-(F2-F1)¹⁰-(F3-F1)¹⁰. In the illustrated embodiments, loop counters 210, 212, 214, 216, and 218 denote the number of itterations required by the associated loops.

### Related Work

Data management optimizations require both the function call information and the control flow information. Since control flow information is so important, data management cannot be performed using just the information in the Call Graph. The Call Graph only has information about which functions call other functions, but it doesn't show an ordering to those calls, or control flow information. Data management techniques can use Global CFG instead (Udayakumaran, et al., 2006; Whitham, et al., 2012; Polychronopoulos, 1991). Global CFG is a graph where all CFGs are inlined to make a single large graph. Indeed Global CFG contains all the information needed, however, the information is arranged in a manner, such that it is compute intensive to dig out the information needed for optimal code mapping.

Other program level level graphs have been defined and used in other contexts. System Dependence Graph (SDG) was designed by Horowitz, et al., 1990. In the SDG, nodes can be split at the sub basic block level to represent individual statements as well as procedure entry and exit points. The SDG also requires different types of edges between the nodes. There are edges that represent control dependence, as well as, flow and def-order dependence. In order to maintain context between procedure calls, a grammar is used to model the call structure of each procedure. While the SDG could be used as input for data management schemes, it is not succinct. The fact that it breaks basic blocks into smaller parts and introduces edges between them makes it quite large. The present disclosure abstracts away the straight line code to provide a succinct representation of the whole program. Udayakumaran, et al., 2006, proposed Data-Program Relationship Graph (DPRG). They start with a call graph, and then append loop and condition nodes for control flow information. However, DPRG does not maintain ordering information, it must use a depth first search to get a general ordering. Also DPRG requires extra nodes for then and else statements, instead of just one node for IF-THEN-ELSE statements, making it less than a succinct representation of the program. Whitham, et al., 2012 proposes a graph called a Control Flow Tree (CFT). They derive this data structure from a control flow graph that has been converted into a tree, and then has been compressed into the final CFT. The graph proposed in their work maintains ordering by making sure that a parent node is always called before a child node. However, they must maintain a list of back edges to keep information about when the leaf of the tree needs to return to an earlier parent. The CFT is not a succinct representation of a program since it needs multiple data structures to represent control flow.

To facilitate data management optimizations on SMM architectures, Lee, et al., 2012 used regular expressions, called path expressions, to represent the way control flows through a program where kleen (*) closure represents a loop, union (j) closure represents a condition, and concatenation (•) closure represents the next segment to be executed. This information reveals the alternating behavior between functions in a program, so that an efficient mapping of function code to memory can be made. The information present in the regular expression is also present in GCCFG, however, it is much easier to annotate GCCFG with more information, like the number of times a loop executes or branch probability, than to annotate a regular expression with more information.

The state of the art data management schemes (Baker, et al., 2010; Bai, et al., 2013; Lee, et al., 2012; Lu, et al., 2013) for SMM architectures have used GCCFG or GCCFG-like data structures, but the construction of GCCFG has not been shown yet. The present disclosure formally defines, and describes the algorithm to construct GCCFGs.

Another representation is Hierarchical Task Graph (HTG) (Polychronopoulos, et al., 1991); however, HTG is only for one function. HTG is a hierarchical representation of the program control flow, and is derived by separating the control flow graph into hierarchies at the loop level. The present disclosure expands the HTG concepts to create an inter-procedural graph, called GCCFG. However, GCCFG construction can become quite challenging when the program has ill-formed control flow, e.g., poorly formed loops, switch statements, and hard to find convergence point of conditions—and the present disclosure provides solutions to correctly construct GCCFG's in these cases.

One embodiment of the present methods, comprises receiving at least one function executed by a computer program; extracting at least one loop in the computer program involving the at least one function; building a global call control flow graph based, at least in part, on the extracted at least one loop and the at least one function of the computer program, wherein the global call control flow graph represents interconnectivity in the computer program; and analyzing a code complexity of the computer program based, at least in part, on the global call control flow graph to manage data on a manycore system. In some embodiments, the step of building the global call control flow graph comprises building at least one hierarchical flow graph based on the at least one loop; building a call control flow graph based on the at least one hierarchical flow graph; and joining the at least one call control flow graph to create the global call control flow graph. Some embodiments further comprise receiving at least one condition executed by the computer program, wherein the step of building the global call control flow graph is further based, at least in part, on the received at least one condition. In some embodiments, the at least one loop comprises one of a poorly formed loop, a switch, a convergence of at least two conditions, a recursive procedure, or an at least one function pointer.

In some embodiments, at least one exit block is added to the hierarchical flow graph. In some embodiments, at least one place holder block is added to the hierarchical flow graph. In some embodiments, at least three distinct representational units are used in building the at least one call control flow graph, the at least three distinct representational units indicating at least a function, a loop, and a condition.

In some embodiments, analyzing the code complexity comprises calculating a total interference of the computer program. And some embodiments further comprise transforming the computer program to reduce the total interference of the computer program.

One embodiment of the present computer program products, comprises a non-transitory computer readable medium comprising code for performing the steps of: receiving at least one function executed by a computer program; extracting at least one loop in the computer program involving the at least one function; building a global call control flow graph based, at least in part, on the extracted at least one loop and the at least one function of the computer program, wherein the global call control flow graph represents interconnectivity in the computer program; and analyzing a code complexity of the computer program based, at least in part, on the global call control flow graph to manage data on a manycore system. In some embodiments of the present computer program products, the step of building the global call control flow graph comprises: building at least one hierarchical flow graph based on the at least one loop; building a call control flow graph based on the at least one hierarchical flow graph; and joining the at least one call control flow graph to create the global call control flow graph. In some embodiments, the non-transitory computer readable medium further comprises code for performing the step of receiving at least one condition executed by the computer program, wherein the step of building the global call control flow graph is further based, at least in part, on the received at least one condition.

In some embodiments, at least one loop comprises one of a poorly formed loop, a switch, a convergence of at least two conditions, a recursive procedure, or an at least one function pointer. In some embodiments, an at least one exit block is added to the hierarchical flow graph. In some embodiments, an at least one place holder block is added to the hierarchical flow graph. In some embodiments, at least three distinct representational units are used in building the at least one call control flow graph, the at least three distinct representational units indicating at least a function, a loop, and a condition.

In some embodiments of the present computer program products, analyzing the code complexity comprises calculating a total interference of the computer program. In some embodiments, the non-transitory computer readable medium further comprises code for performing the step of transforming the computer program to reduce the total interference of the computer program.

Some embodiments of the present apparatuses comprise a memory; and processor coupled to the memory, wherein the processor is configured to execute the steps of: receiving at least one function executed by a computer program; extracting at least one loop in the computer program involving the at least one function; building a global call control flow graph based, at least in part, on the extracted at least one loop and the at least one function of the computer program, wherein the global call control flow graph represents interconnectivity in the computer program; and analyzing a code complexity of the computer program based, at least in part, on the global call control flow graph to manage data on a manycore system. In some embodiments, the step of building the global call control flow graph comprises: building at least one hierarchical flow graph based on the at least one loop; building a call control flow graph based on the at least one hierarchical flow graph; and joining the at least one call control flow graph to create the global call control flow graph. In some embodiments, the processor coupled to the memory is further configured to execute the step of receiving at least one condition executed by the computer program, wherein the step of building the global call control flow graph is further based, at least in part, on the received at least one condition.

In some embodiments, the at least one loop comprises one of a poorly formed loop, a switch, a convergence of at least two conditions, a recursive procedure, or an at least one function pointer. In some embodiments, an at least one exit block is added to the hierarchical flow graph. In some embodiments, an at least one place holder block is added to the hierarchical flow graph. In some embodiments, at least three distinct representational units are used in building the at least one call control flow graph, the at least three distinct representational units indicating at least a function, a loop, and a condition.

In some embodiments, the step of analyzing the code complexity comprises calculating a total interference of the computer program. In some embodiments the processor coupled to the memory is further configured to execute the step of transforming the computer program to reduce the total interference of the computer program.

As used herein the specification, “a” or “an” may mean one or more. As used herein in the claim(s), when used in conjunction with the word “comprising”, the words “a” or “an” may mean one or more than one.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” may mean at least a second or more.

Throughout this application, the term “about” is used to indicate that a value includes the inherent variation of error for the device, the method being employed to determine the value, or the variation that exists among the study subjects.

Other objects, features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1A is an example of a simple program containing six functions, a conditional, and a loop.

FIG. 1B illustrates a GCCFG representation of the program in FIG. 1A.

FIG. 1C illustrates one embodiment of the present methods for constructing a GCCFG.

FIG. 2 illustrates two parts of optimal code mapping: (i) divide the code space on SPM into regions, and (ii) mapping functions into regions. Functions mapped to the same region replace each other when called. Consequently, for a given code space, dividing the space within regions and mapping of functions into regions is desired so that there is minimum data transfer between SPM and the main global memory.

FIG. 3A illustrates a call graph.

FIG. 3B illustrates one embodiment of a GCCFGs for the weighted call graph in FIG. 3A.

FIG. 3C GCCFGs in 3B and 3C have different sequences of function execution.

FIG. 4 illustrates a set of loops in a CFG where each loop contains all of the basic blocks of itself and all loops nested inside of it.

FIG. 5A illustrates HFGs extracted from the CFG in FIG. 4.

FIG. 5B illustrates a forest of DAGs after all the HFGs have been transformed.

FIG. 6 illustrates mapping basic blocks to vertices to be used in a CCFG.

FIG. 7 illustrates constructing edges in a CCFG by finding the path from a condition block to a convergence block for the condition in the HFG. Along that path there are other FPH, LPH, and condition blocks.

FIG. 8 illustrates a CCFG G' vertex that must become the child of the condition vertices parent where the block of interest (loop 3 in HFG L′) appears after a condition convergence block (e.g., B3).

FIGS. 9A-9D illustrate challenging cases for GCCFG creation and solutions.

FIG. 9A illustrates two intertwined loops that may be “transformed to be represented as” one well defined loop.

FIG. 9B illustrates a loop with many exits that may be a well-defined loop with only one exit point.

FIG. 9C illustrates a switch block that may be a series of intermediate blocks where each block has at most two children.

FIG. 9D illustrates that a condition without a convergence point may be rejoined to the program flow by adding an exit block from the HFG.

FIG. 10 illustrates common Loop Place Holders that may be glued together at a common vertex to make a GCCFG.

FIG. 11 contains experimental results of the compilation time when applying Code Mapping to benchmarks using GCCFG's Global CFG's as inputs.

FIG. 12 contains experimental results of the compilation time when applying Stack Management to benchmarks using GCCFG's Global CFG's as inputs.

FIG. 13 illustrates that the size (in number of nodes) of a GCCFG may be about 9× less than a Global CFG, with various benchmarks

FIG. 14 illustrates one embodiment of the present disclosure for building a Global Call Control Flow Graph.

### DESCRIPTION OF ILLUSTRATIVE EMBODIMENTS

### Global Call Control Flow Graph

The Global Call Control Flow Graph or GCCFG, of the present disclosure is a whole program view of structures within an application. Specifically, GCCFG identifies three different types of structures that are commonly found in programs: function calls, loop blocks, and if-then-else condition blocks.

Definition 1: (GCCFG) Let G: =(V;E) be a DAG, where V={Vf ∪ Vc ∪ V1} is a set of vertices representing program structures and {e=(v1,v2)∈E:v1∈VΛv2 ∈V} is a set of directed edges. Then G is a GCCFG of a program where the vertices identify three program structures, function calls, loops, and if-then-else conditions respectively, and the edges represent the change of control flow in a program structure; where the program code in v2 is called from inside the program code corresponding to v1.

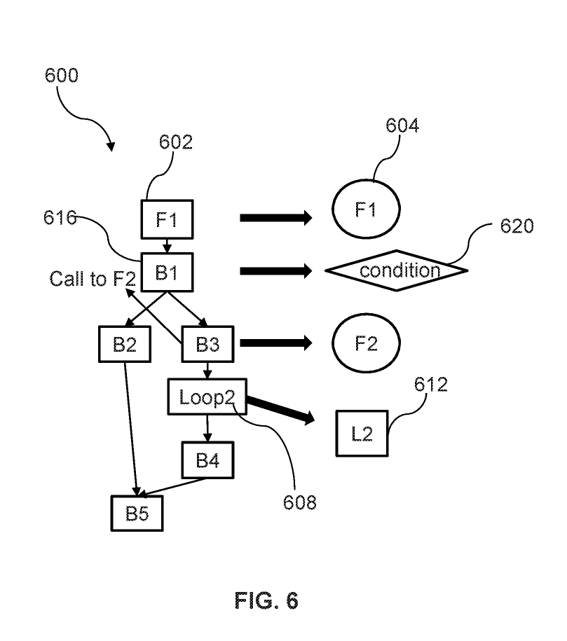

The three types of program structures represented by the vertex set in GCCFG are distinguished in the following ways: A vertex v ∈ Vf represents a function call in a program, has only one set of outgoing edges, and is represented, in some embodiments, by a circle shape in the final GCCFG graph, e.g. 404 of FIG. 6. The vertex v ∈ Vl represents a loop in a program, also has only one set of outgoing edges, and is represented, in some embodiments, by a square in GCCFG, e.g. 412 of FIG. 6 Finally, a vertex v ∈ Vc represents an if-then-else condition in the program, where it has two sets of outgoing edges. One set of outgoing edges represent the path that control takes when the condition is true, and the other represent when the condition is false. A condition vertex is represented in GCCFG, in some embodiments, as a diamond shape, e.g. 420 of FIG. 6. A set of outgoing edges from any vertex is an ordered set where vertices connected to edges on the left are executed before vertices to the right of them.

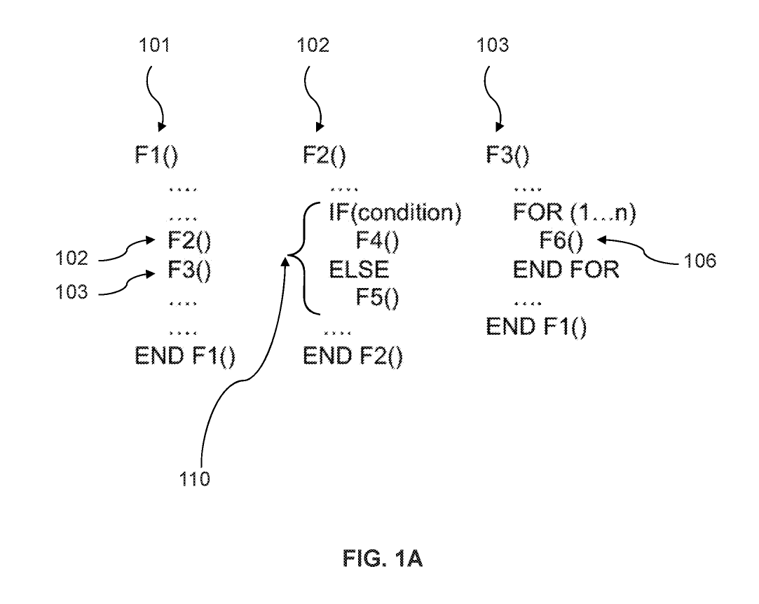

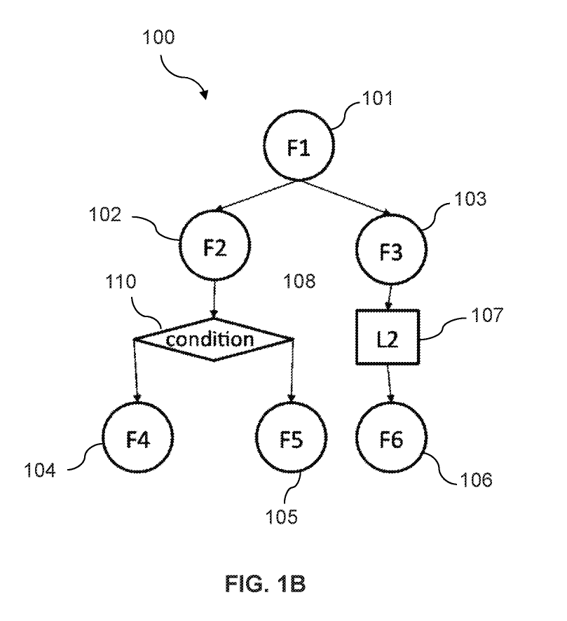

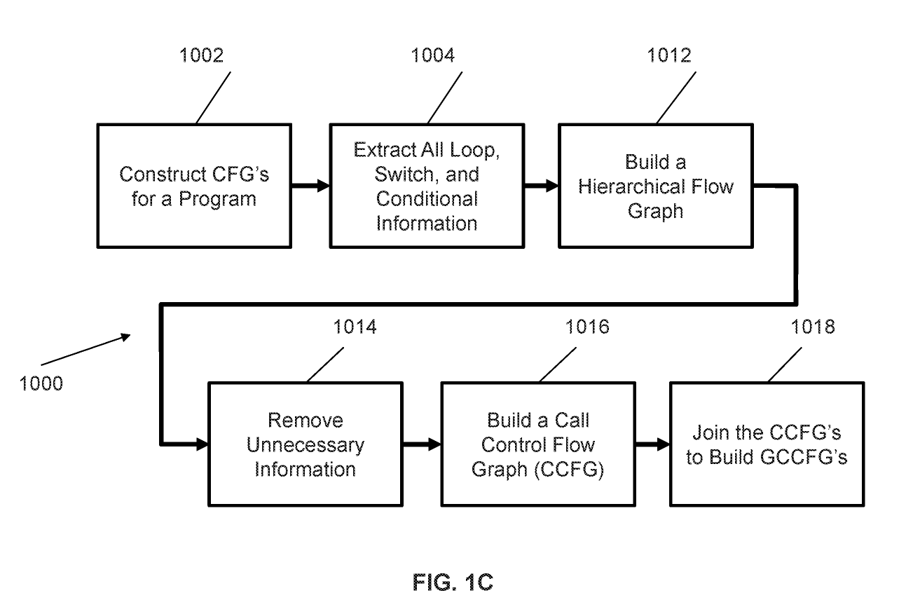

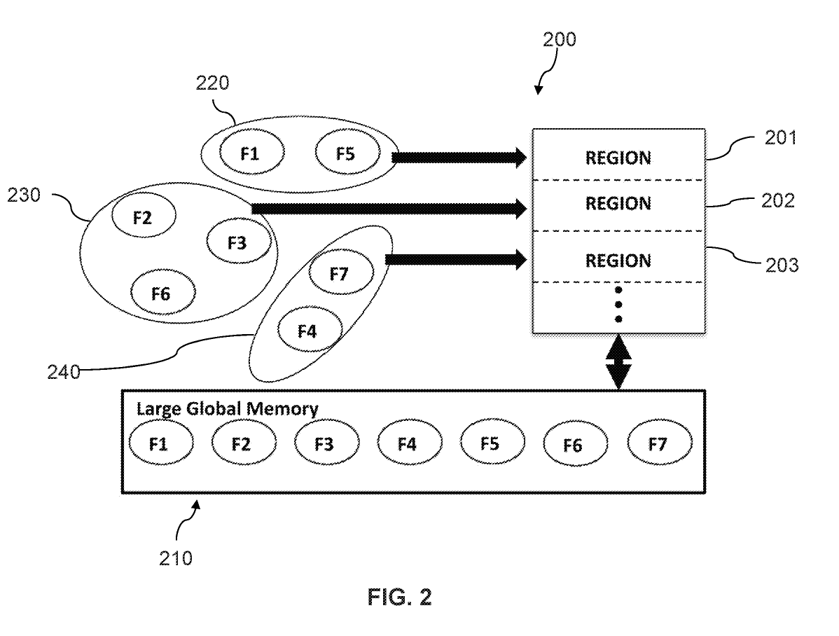

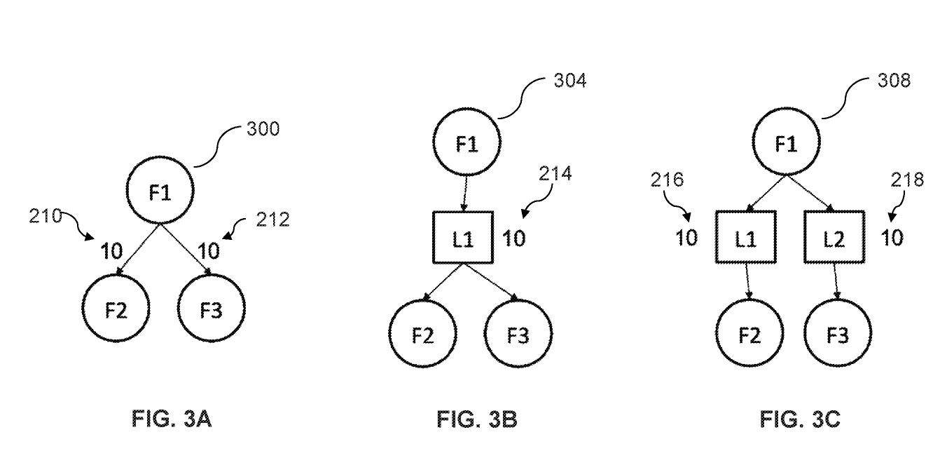

The GCCFG of the example program in FIGS. 1A and 1B, has Vf={F1,F2,F3,F4,F5,F6}, Vl={L2}, and Vc={condition}. The GCCFG represents a program that starts with function F1 (101). Inside F1, two functions are called F2 (102) and F3 (103) in the order. Inside F2, there is an if-then-else 110, in which F4 is called in the true path, and F5 is called in the false path. Inside F3 (103), the function F6 is called in a loop. Functions F4, F5, and F6 have only straight line code.

A. How to Construct GCCFG. One embodiment of the present GCCFGs may be constructed as shown in FIG. 1C. In the embodiment 1000, a GCCFG is constructed from the set of Control Flow Graphs (CFG) of a program at steps 1002. As each CFG represents a procedure in a program, a procedure may be viewed as a hierarchy of loops by extracting all loop, switch, and conditional information from the program in Step 1004. Hierarchical flow graphs may be constructed in some embodiments in step 1012. Each hierarchy can be viewed as its own graph, and examined for necessary and unnecessary information. We can remove the unnecessary information from each hierarchy in step 1014 and glue the condensed graph to the other hierarchies in step 1016 Finally, we can glue all procedure graphs together at call sites to create a succinct whole program graph in step 1018.

1) Step 1: Extracting Loop Information: A Program p ⊃ CFG H, where H=(B;E), represents a single function in a program. B is the set of basic blocks in the function, and E is the set of edges between basic blocks (Ferrante, et al., 1987).

Given a set of CFGs, which in some embodiments may be already been performed in step 1002 of FIG. 1C, the next steps, 1004 is to extract the loop information from them. This information is found in strongly connected components (Ferrante, et al., 1987). Some embodiments assume that each loop has a unique entry block and a unique exit block. If a loop doesn't have unique entry block and a unique exit block, some embodiments will convert the loop to have unique entry and exit blocks.

Definition 2: (LOOP) Each Loop L ⊂ H, where Li=(B_{Li}; E_{Li}) and H=(B;E) represents control flow graph of a program. B_{Li} ⊂ B are the blocks in a loop and the loops nested within it. E_{Li} ⊂ E are the edges between the blocks in a loop.

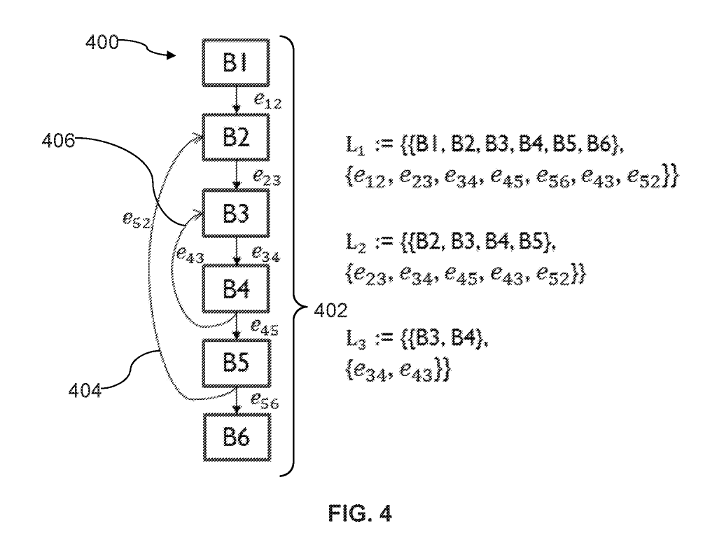

Definition 2 explains that a loop is a set of blocks and a set of edges that are both a subset of the blocks and edges in a CFG. FIG. 4 shows how the loop sets are extracted in some embodiments. In the example, Loop 2 (L2) contains the information about Loop 3 (i.e., L2 fully contains L3), while Loop 3 only has information about itself In this work Loop 1 is a special case, which has all of the blocks and edges from the entire CFG. Namely, L1=(B_{L1}; E_{L1})=H.

2) Step 2: Constructing Hierarchical Flow Graph: The next step after extracting the loop information is to separate the loops into hierarchical levels. All nested loops are a subset of the loop they are nested inside, so we identify which loop is one level of nesting below another loop. Therefore, ∀L(LV (L)→>level) where the function LV finds the level of the loop.

In this work L₁ will always have the highest level hierarchy. So following the example in FIG. 4: LV (L₁)→>1, LV(L₂)→2, and LV(L₃)→3.

By separating all of the loops in a CFG and identifying the hierarchy where they appear, we can use the loop information to build a new graph called Hierarchical Flow Graph (HFG), e.g. step 1012 of FIG. 1C. A HFG contains basic blocks and edges, where the blocks and edges hold the same meaning as a loop. A HFG also contains two new types of blocks: Loop Place Holder (LPH), and Function Place Holder (FPH). Both of these blocks represent an entry into a loop and a function respectively. Further the LPH and the FPH are used at the entry to a function or loop and at the call site for the corresponding loop or function. Each FPH and LPH is annotated with a label identifying which loop, or function it is a place holder for.

Definition 3: (Hierarchical Flow Graph) An HFG HFG L′=(B′_{L}, E′_{L}) is a DAG, where B′_{L} represents all of the basic blocks in a loop plus one LPH for each highest level nested loop, and one FPH for each function call in the loop. E′_{L} is the set of edges between B′_{L}. An HFG has either an LPH or an FPH to denote if it is above the highest level loop, or one of the loops in a function.

Algorithm 1 (below) explains how to separate nested loops into different graphs. The algorithm starts by copying all blocks and edges to the sets B′_{L} and E′_{L} respectively in lines 1 and 2. It then cycles through all nested loops that are at the first level of nesting below the loop L. It finds a nested loop K, as K is a proper subset of L and its nesting level is one more than L, so in lines 4 and 5 it removes the blocks and edges that are in K and also in L′. In line 6 the algorithm examines each edge in the original loop L; if the head or tail is in K, then the edge is removed from L′ and a new edge is added to L′. The new edge connects to a new node that is a LPH, where the one entry edge to the loop K now connects to LPH and the exit from K, also connects to LPH. The complexity of Algorithm 1 is dependent on the number of loops that are nested within one level of another loop. Therefore the time complexity of this algorithm would be O(n*b), where b is the number of blocks in the outer loop and n is the number of loops nested in it.

Algorithm 1: Build HFG

| | Input: A loop L = (B_{L}, E_{L}) |
|---|---|
| | Output: An HFG L′ = (B′_{L}, E′_{L}) |
| 1 | B′_{L} ← B_{L} |
| 2 | E′_{L} ← E_{L} |
| 3 | forall the K ⊂ L: LV (K) = LV (L) + 1 do |
| 4 | B′_{L} ← B′_{L} − B_{K} |
| 5 | E′_{L} ← E′_{L} − E_{K} |
| 6 | forall the ε ε E_{L} : e = (b₁, b₂) do |
| 7 | if (b₁ ε {B_{L} − B_{K}}) \hat{ } (b₂ ε B_{K}) then |
| 8 | B′_{L} ← B′_{L} + {LPH} |
| 9 | E′_{L} ← E′_{L} − {e} + {e′ : e′ = (b₁, LPH) |
| 10 | if (b₁ ε B_{K}) \hat{ } (b₂ ε {B_{L} − B_{K}}) then |
| 11 | E′_{L} ← E′_{L} − {e} + {e′ : e′ = ( LPH, b₂)} |

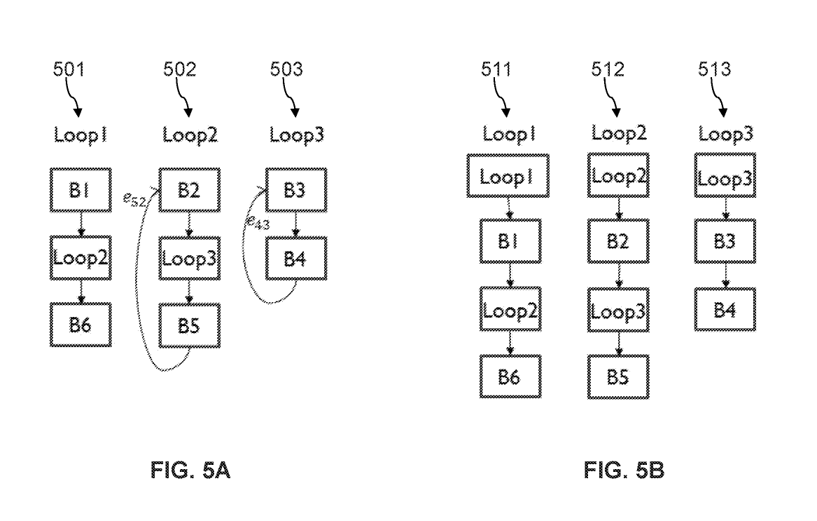

FIG. 5A shows how the example CFG 400 in FIG. 4 will become several graphs, 501-503, after applying algorithm 1. In the original CFG 400 of FIG. 4 there are 3 nested loops, 402, 404, and 406, at different levels that correspond to loops L1, L2, and L3, respectively. Each corresponding HFG, e.g., 501, 502, and 503 in FIG. 5A, gets an LPH to represent the blocks and edges that were there.

What is needed to move beyond this stage is a forest of DAGs, so that the HFG information can be used to build a more condensed graph. The first step is to remove any back edges, and to add a new root block. If the HFG is a loop, its root block becomes a LPH, and if it is the highest level HFG, its root block becomes a FPH. FIG. 5B shows an example of a forest of DAGs after this final transformation where DAGs 511, 512, and 513 are the DAGs for HFGs 501, 502, and 503, respectively.

3) Step 3: Building Call Control Flow Graph: We must traverse the HFGs in a Depth First Search (DFS) and build a graph, that condenses the information present in the HFG, into a graph called the Call Control Flow Graph (CCFG). A CCFG is a proper subset of GCCFG, it is constructed when a block of interest is found on an HFG, we then apply a set of rules to construct the proper vertexes and edges in the CCFG. A block of interest is a block with two outgoing edges, a LPH, a FPH, or a block with a function call in its code.

Definition 4: (Call Control Flow Graph) A CCFG G′=(V′, E′), where given a GCCFGG [symbol] G′⊂ G. V′ is a set of vertices representing program structures of a loop, function call, or if-then-else. E′ is the set of edges connecting the program structures.

Algorithm 2 and Algorithm 3 explain how to build a CCFG given the information present in an HFG. First, Algorithm 2 gives three of the rules, for building a CCFG, by showing the cases for building verticies. The first rule, is found at line 2 of Algorithm 2, where there is a condition in the program, therefore a condition vertex is added to the set of vertices, in the CCFG G′. The second rule, is found at line 5 where a loop is found, then a loop vertex is added to the vertex set in G′. Finally, if the block contains a call to another function or is a FPH at line 8 then a function vertex is added to the vertex set in G′. At lines 4, 7, and 10 a mapping between the block in L′ and the vertex in G′ is created, as shown in FIG. 6 (this will be necessary later). FIG. 6 is an exemplary HFG 600 whereas an FPH 602 is mapped to a circle vertex 604, a LPH 608 is mapped to a square vertex 612, and an if-then-else condition 616 is mapped to a diamond vertex 620. The complexity of Algorithm 2 is based on the number of blocks in an HFG. Each block must be examined, and in the worst case, each line of code in the block must be examined to determine if there is a function call. Therefore the complexity is O(b*1), where b is the number of blocks in an HFG and 1 is the number of lines in the largest block.

Algorithm 2: Build CCFG

| | Input: An HFG L′ = (B′_{L}, E′_{L}) |
|---|---|
| | Output: A CCFG G′ = (V′, E′) |
| 1 | forall the b ε B′_{L} do |
| 2 | if Out Degree(b) := 2 then |
| 3 | V′ ← V′ + {v ε Vₙ} |
| 4 | m : b [symbol] v |
| 5 | if b := LPH then |
| 6 | V′ ← V′ + {v ε Vᵢ} |
| 7 | m : b [symbol] v |
| 8 | if (b := FPH) v (CodeContainsFunction(b)) then |
| 9 | V′ ← V′ + {v ε Vⱼ} |
| 10 | m : b [symbol] v |
| 11 | DepthFirstSearchHFG(Root(L′),G′) |

Algorithm 3: Depth First Search HFG

| | Input: A Basic Block of an HFG b₂ ε B′_{L}, A CCFG G′ |
|---|---|
| | Output: A CCFG G′ |
| 1 | if Out Degree(b₁) := 2 [symbol] (m : b₁ ε V′) then |
| 2 | forall the p ε P\|p := {b₁, . . . , bₙ} do |
| 3 | ConvergeBlock = HighestCommonDescendant(P) |
| 4 | forall the b ε p\|(b > b₁) [symbol] (m : b₁ ε V′) do |
| 5 | if b ≦ ConvergeBlock then |
| 6 | E′ ← E′ + {e = (m : b₁, m : b)} |
| 7 | if TrueCondition(b₁) then |
| 8 | AddTrueSet(m : b₁, ε) |
| 9 | else |
| 10 | AddFalseSet(m : b₁, ε) |
| 11 | else |
| 12 | v = Parent(m : b₁) |
| 13 | if v ∉ V_{c} then |
| 14 | E′ ← E′ + {e = (v, m : b)} |
| 15 | forall the b₂ ε Children(b₁) do |
| 16 | DepthFirstSearch(b₂,G′) |

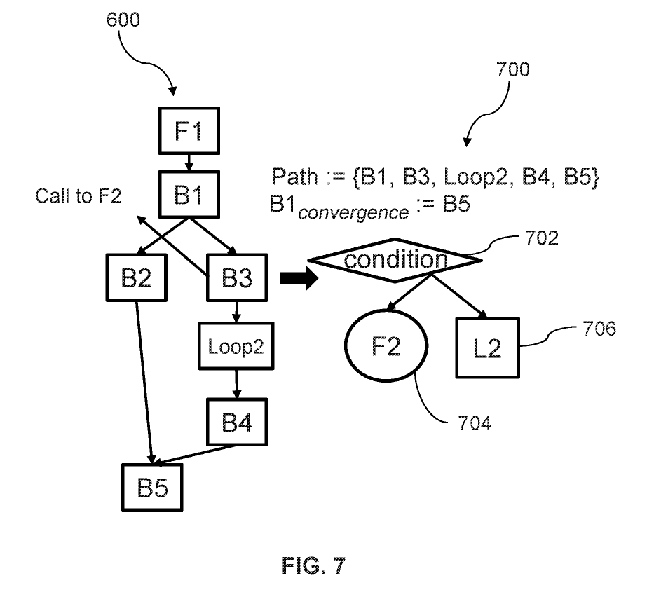

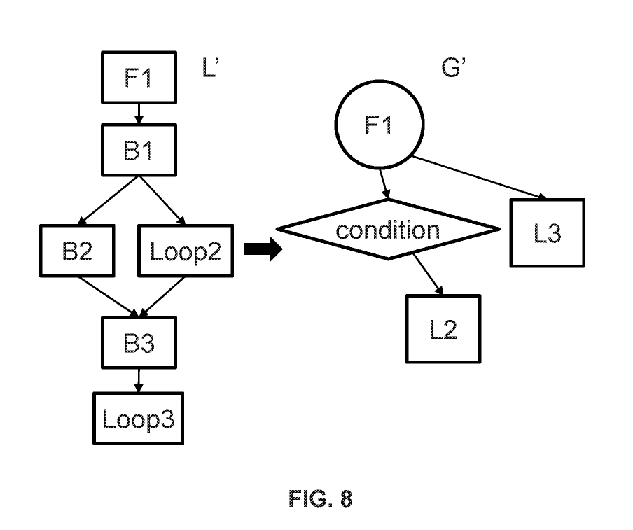

Algorithm 3, called from algorithm 2 is a recursive function, which describes the remaining rules for building CCFG. First at line 1 we locate a condition, that also is mapped to a vertex in V′. Then, we examine all true and all false paths through the graph, that appear after the condition diverges and before it converges. The fourth rule for creating a CCFG appears at line 6 and line 7, where if another block mapped to the CCFG is found then a true edge is added to the CCFG. The fifth rule appears at line 6 and line 9, which like the previous rule adds an edge, but now adds a false edge in the CCFG. This case is illustrated in FIG. 7, where false edges are created. For example, the HFG 600 contains block B3 and the program progresses to Loop2 and then to block B4. Block B3 also calls function F2. Accordingly, some embodiments of the present CCFGs created false edges between sequential blocks. For example, B3 is mapped as a conditional block 702, Loop2 is mapped as loop block L2 and the function call to F2 contained in block B3 is added to the CCFG as false edge 704, and false edge L2, which, in CCFG sample 700, no longer shows block B4 stemming from L2 at block 706, as it did in HFG 600. The final rule, for building GCCFG, appears at line 13 where the block of interest appears after the condition converges. In this case an edge is created between the node and the parent of the condition. This case is illustrated by FIG. 8 where the block of interest is after the convergence so the edge is created with the parent of the condition. The complexity for Algorithm 3 is O(b*p), where b is the number of blocks in an HFG and p is the largest number of paths starting at a condition block in the HFG. The Highest Common Descendant has a complexity of O(h), where h is the height of the graph. In some embodiments the traversal information is stored from the highest common descendant algorithm to build all of the paths in the graph, therefore the complexity is affected by the largest path and not the height of the graph.

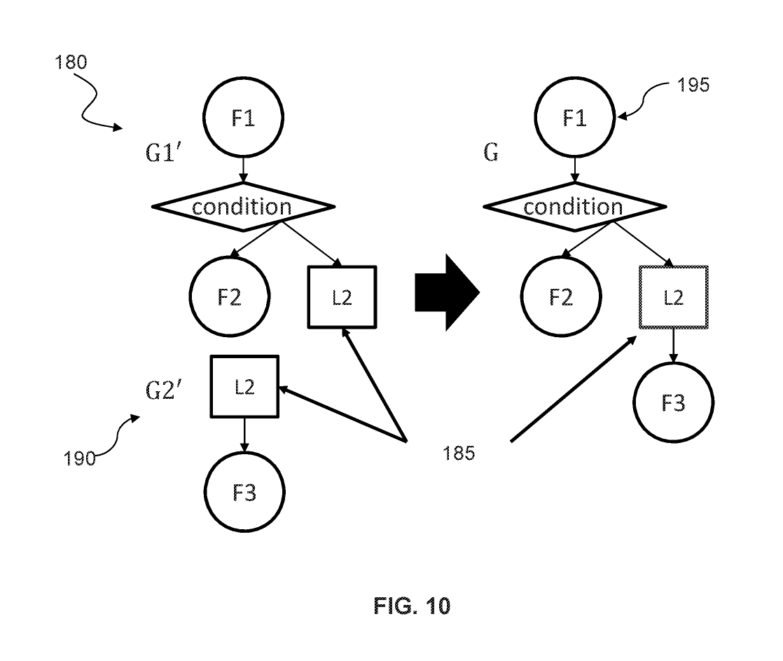

4) Final step: Integrating Call Control Flow Graph: After we have built a CCFG for every HFG in the program, we can glue the CCFG's together. FIG. 10 illustrates how this is done. If there are loop vertices in two CCFGs with the same label then they become one vertex, gluing the two graphs together. This same gluing technique is applied if both are function vertices. For example in FIG. 10, CCFG 180 (G1') and CCFG 190 (G2') share node L2 in common. Accordingly, some embodiments of the present disclosure create GCCFG (e.g., 195) by fluing CCFG 180 and CCFG 190 together at their common node, glue point 185 (e.g., the L2 node in the illustrated embodiment). Once all CCFGs have been glued together there will be one large graph, which is a GCCFG.

B. Challenges cases in GCCFG construction. Till now, we have explained the definition and construction of GCCFG in a typical setting. However, several times the input program graphs are ill-formed, and that makes the task of building GCCFG challenging of Challenge cases include a program that is constructed with poorly formed loops, a program which contains switch statements, finding the convergence point of some conditions, how to represent recursive procedures, and how to represent function pointers. These problems must be addressed to be able to successfully build GCCFG.

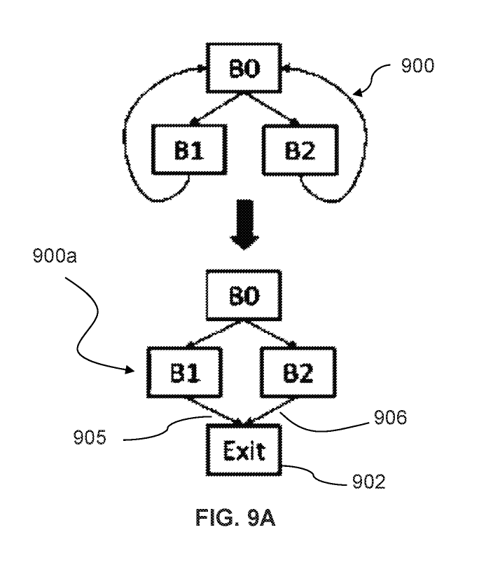

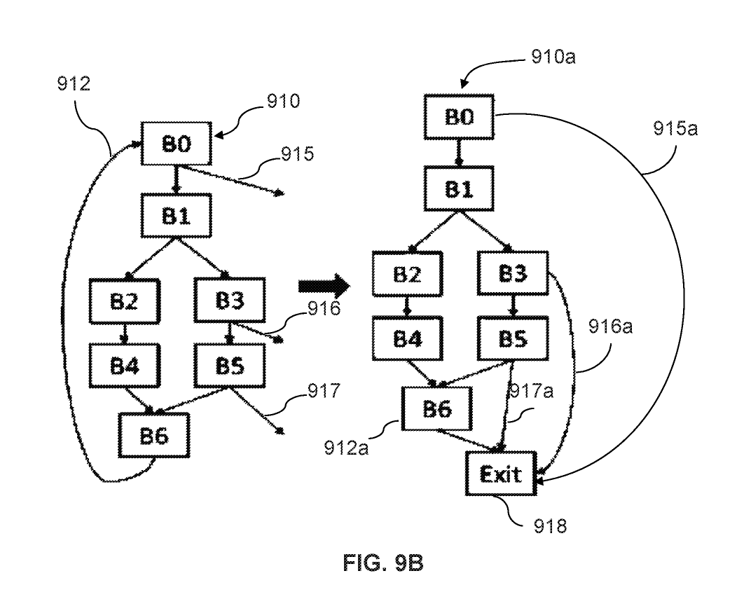

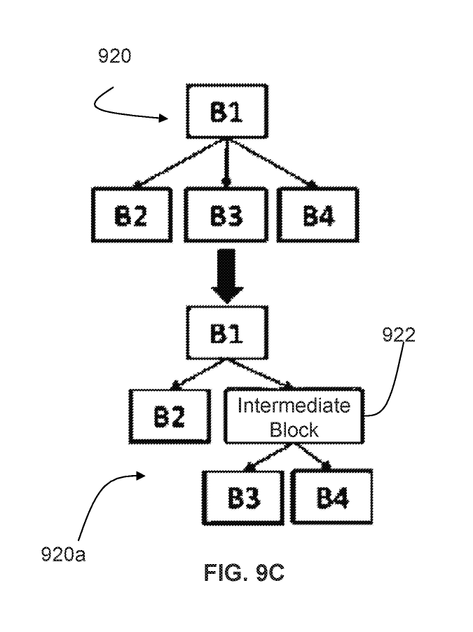

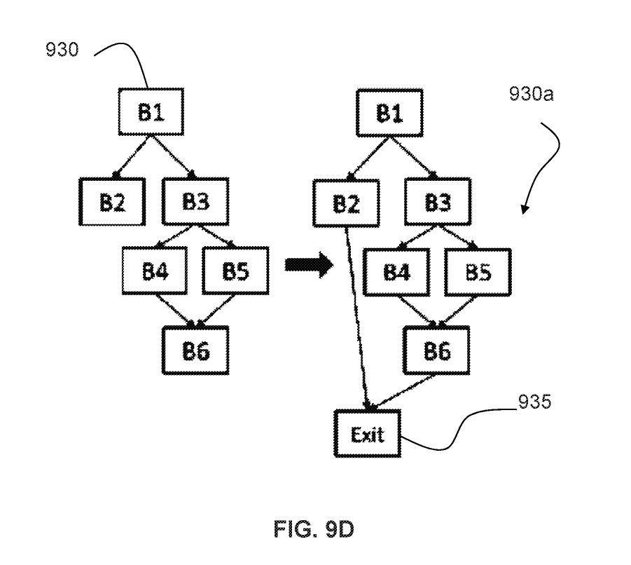

1) Poorly formed loops: The first challenge to address is that of poorly formed loops. These include, loops that have multiple exits (commonly caused by continue, break, and goto statements), and intertwined loops (caused by goto statements). Both of these types of loop problems must be removed before transforming the basic blocks into a final HFG. FIG. 9A, in top graph 900, shows an example of an intertwined loop. This loop can return to its head block from either loop body B1 or B2, making which loop body executes non-deterministic. FIG. 9B, in left graph 910, shows a loop 912, with many exits 915-917. It cannot be determined which basic block will execute immediately following the conclusion of the loop. The process for dealing with this challenge is the same for either case, we must create a unique entry and exit point for a loop. FIG. 9A, bottom graph 900a, shows how a unique exit block 902 is added to the graph and all back edges are attached to it, effectively making two loops into one. FIG. 9B, right graph 910a, shows how adding a unique exit block 918 and having all exit edges, 912a, 915a, 916a, and 917a, point to it, makes the loop exit deterministic, while maintaining the control structure of condition blocks. The transformation illustrated in FIG. 9A loses the information about all but one of the loops intertwined with others. However, none of the control flow information resulting from if-then-else statements is removed. Since one of the useful traits of GCCFG is determining which loops are nested within other loops, saving intertwined loops does not provide useful information. Therefore the transformation illustrated in FIG. 9A saves the relative information that the blocks that were part of the intertwined loops are still part of a loop, and conserves all other control flow information. The transformation in FIG. 9B does not lose any control flow or loop related information when transformed from graph 910 to graph 910a.

2) Switch statements: The second challenge to address is programs with switch statements. While switches are not poor programming practice the challenge is that a single block's children cannot be broken down into true and false children. The present disclosure applies, in some embodiments, a transformation in to distinguish true and false children by adding an intermediate block to the graph. The top part in FIG. 9C shows what a sub graph 920 of a CFG would look like where B1 has all of the switch conditions, and B2 through B4 has each case for the switch. The graph on the bottom side 920a of FIG. 9C shows how the graph looks after transformation. All children of the switch except B2 are removed and an intermediate block takes their place. The removed children become descendants of the intermediate block 922, and if there are more than two children left, this process is repeated until each block has at most two children. No information will be lost in the process of adding intermediate blocks as this is simply a place holder without any code in it. It also does not add or take away any control flow information as the number of edges leading to each condition of the switch hasn't changed.

3) Finding a convergence point: Another challenge to address is finding the convergence point of a condition with exit statements. These are mostly caused by error conditions that exit the program immediately. In the representing CFG the block with the exit has no descendants, so it is not clear what the corresponding convergence block would be. If there are nested conditions within this condition on the true or false paths it further confuses the issue as the convergence point of the nested condition may appear to occur after the convergence of parent condition. The solution to this challenge is similar to the loop problem in that each CFG must have a unique exit block. FIG. 9D shows a graph 930 with an exit at B2, most likely caused by an error check in the program, while the graph 930a on the right shows how the block now has an edge pointing to a unique exit 935. This can cause a control flow problem in this program now as it appears that an error may in fact allow execution to continue. Some embodiments annotate the edge and block so that if a block of interest occurs after the error, it will have less weight in the final GCCFG. Adding a new edge from a program exit to a new place holder exit does not change the program as the exit block is simply a place holder and doesn't have any useful information inside of it. There is no added control flow information as only one outgoing edge is added to the program exit block. This transformation just makes HFG graph traversal much easier when finding blocks of interest.

C. Recursion and Function Pointers. Up to this point call sites have represented an edge from one vertex to a function vertex. However, when a program contains recursion some embodiments need to be able to represent that control has been given back to the entry point of the recursive procedure. To continue with the trend in GCCFG of having a unique function vertex for control to move to, would not adequately represent the control flow contained within the recursive procedure, or would require that we duplicate all of this information in the graph. Therefore, we introduce a back edge in GCCFG. Any back edge in the graph represents a recursive procedure call, where the edge starts at the call site and ends at the recursive procedures function vertex. It is important to note, that there is no structure in Global CFG to handle recursive programs. The Global CFG requires that when a function call occurs a function's CFG is inserted in its place, and this is not possible in Global CFG.

Determining the set of functions that a pointer can point to requires program analysis, where the most conservative results, which run quickly, will give a much larger set than a more accurate analysis, which will take a longer time. The tradeoff lies in choosing between accuracy and speed for pointer analysis. GCCFG needs to be generated quickly as a benefit to doing more data management analysis at compile time, and needs to be succinct for those analyses. Some embodiments use the pointer analysis presented in (Milanova, et al., 2004), where a less accurate model gives enough information to determine which pointers will be equivalent at compile time and placing the corresponding functions and their pointers into an equivalence class. This relationship between pointers and the functions they may point to is used to generate an edge between the call site where the pointer exists and the functions in the equivalence class. In GCCFG these special edges will be represented by dotted lines.

### Experimental Results

A. Experimental Setup. Experiments were to demonstrate the need, and usefulness, of GCCFG over Global CFG. The experiments are for code management, and stack data management optimizations in SMM architectures. To do that, an embodiment of the present disclosure was implented to construct GCCFG in an LLVM compiler. Since a pass can only be applied on a single source code file, the llvm-link utility was used to transfer several bitcode files into one bitcode file. A Function Pass in LLVM, which operates on each function of a program was implemented. The function pass extracted control flow and loop information from each function and stored it in a data structure. After all the passes had finished the extracted information was combined into a GCCFG. GCCFG nodes and edges were annotated with information necessary for code and stack data management. For comparison purpose, Global CFG's were also generated. The code and stack management implementations get information about the program from GCCFG (or Global CFG) through some functions, like estimatelnterferenceCost that can be computed using both GCCFG and GlobalCFG. Next, LLVM passes were run for code (Bai, et al., 2013) and stack data management (Lu, et al., 2013). A compiler was run on benchmarks from the Mibench suite (Guthaus, et al., 2001) to compare the compilation time.

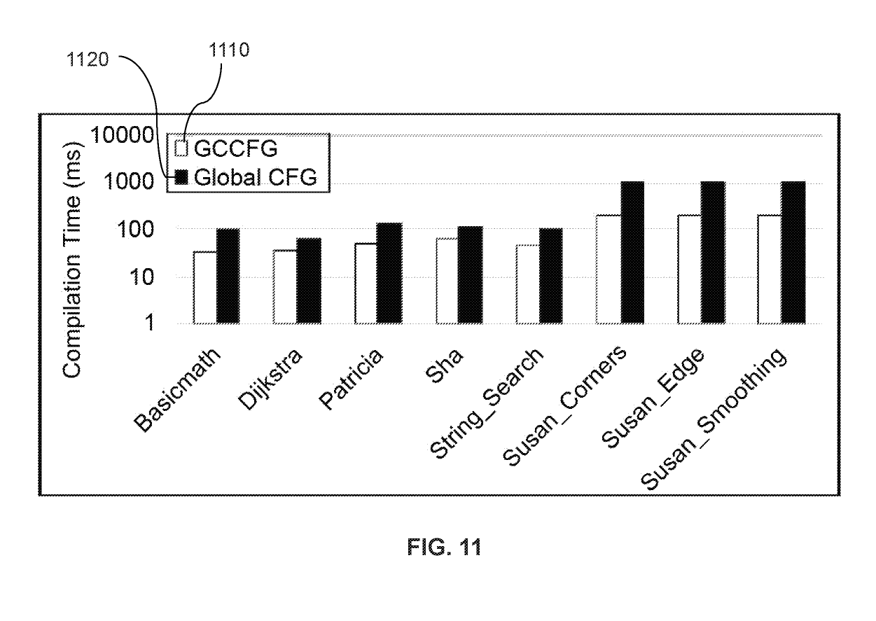

B. GCCFG makes code management 5× faster as compared to Global CFG. FIG. 11 plots the time (in milliseconds) to perform code mapping on benchmarks using GCCFG 1110 and Global CFG 1120. The results show that across all the benchmarks there was a consistent speedup of around 5×. To dig deeper in where the benefits are coming from, the average amount of time it takes to do a single step of code management (Bai, et al., 2013) for each benchmark was measured. Initially all the functions are mapped to their own sections. Then in each step the functions in two regions are merged to make one region. The two regions that will cause the least increase in the data transfers between the global main memory and the local SPMs must be selected for merging. This must be done until the code space constraint is met. In each step, the code mapping algorithm needs the estimate of data transfers between the global main memory and the local SPMs for a given mapping, called interference, and that is calculated using GCCFG (by algorithm 4) and using Global CFG (by algorithm 5). On average, a single pass of code management Global CFG takes 8 times longer than for GCCFG. This is caused by the fact that on each step of Code Management the necessary information must be extracted from the graph before moving on to the next step. Since Global CFG is so much larger it takes much longer than GCCFG to extract this information.

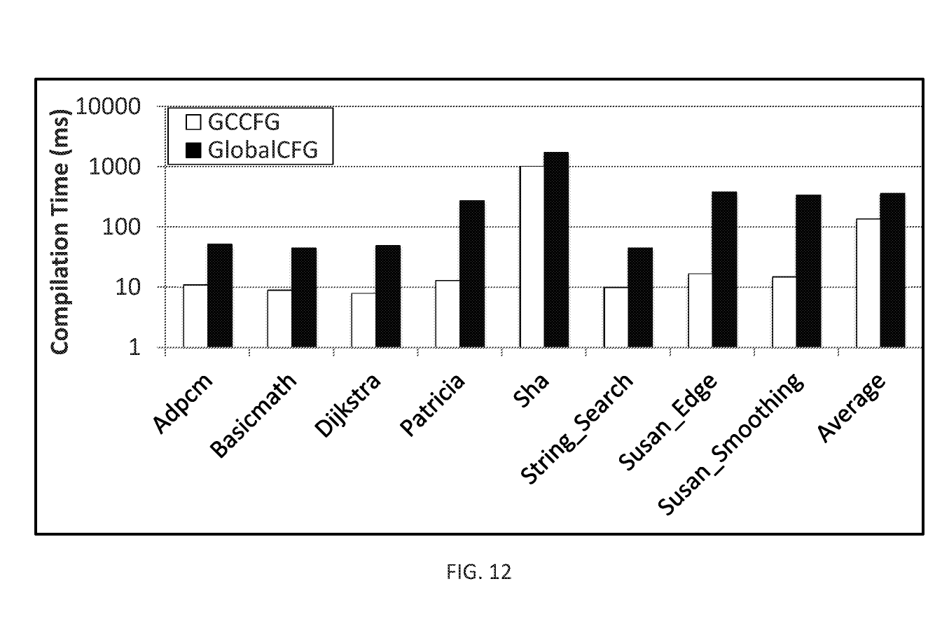

C. GCCFG makes stack management 4× faster as compared to Global CFG FIG. 12 plots the runtimes of the stack management with GCCFG and Global CFG. In the case of stack mapping the algorithm runs on a reduced graph with only vertices representing functions, therefore Global CFG must be reduced at every iteration where the data structure must be traversed. Therefore, we see an average speedup of 4× using GCCFG over Global CFG. To dig deeper into this, the time for each step of stack management was computed. In a single pass of stack management, stack frames were combined together into sets on a single path of execution. Then the set was modified slightly to determine if a different set of stack frames will provide a more efficient execution time for the application. On average a single pass takes eight times longer with Global CFG than it does with GCCFG. The reason is again because Global CFG is much bigger than GCCFG, and Stack Management needs to extract the necessary information from Global CFG before it can move on to the next step.

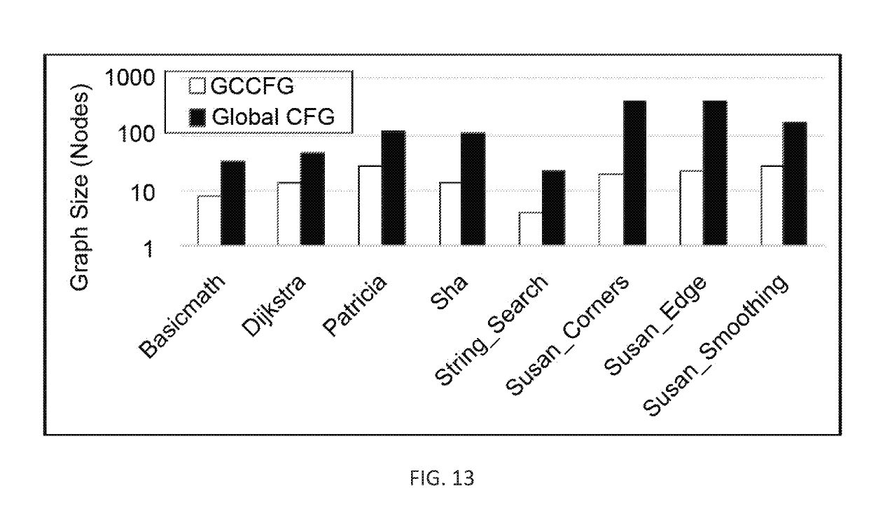

D. GCCFG is succinct representation of the program. FIG. 13 plots the number of nodes in GCCFG and Global CFG for the benchmarks We can see that on average Global CFG is nine times larger than GCCFG, which is due to the fact that Global CFG has nodes that represent stops along paths that lead to code that is not a function. Global CFG also has nodes that represent sequential intermediate parts of a program, while GCCFG only has nodes that represent control flow information leading to function calls. However Global CFG is very quick to build—almost 200× faster. That is because to construct Global CFG we only need to connect an edge from a function call site to a function's first basic block. However, even GCCFGs for all the benchmarks are built in less than a second (while code management for example, can take tens to hundreds of seconds), so the build time is not so important.

### Complexity Analysis of Using GCCFG and Global CFG

Experiments also analyzed the algorithms to generate the information required for code and stack data management to compare the complexity of those algorithms. This was done to illustrate how succinct a representation GCCFG is.

A. Interference calculation using GCCFG. Algorithm 4 shows how code mapping determines the total interference of a program based on a mapping of functions to regions (Baker, et al., 2010). Interference is the amount of data transfers that will take place between the local SPM and the global main memory for a given mapping. The input M is a mapping of functions to regions. At lines 1 and 2 the algorithm iterates over all pairs of functions in the program that are mapped to the same region in memory. At lines 3 and 4 if function I is the Lowest Common Ancestor (LCA) of the two functions then the total interference will have the number of times the function is called during execution plus the number of times the first function on the path from i to j is called. Lines 5 and 6 do the same thing as 3 and 4 except j is the LCA of the two functions. Finally, at line 8 if neither i or j are the LCA of the other, the number of times the actual LCA of the two functions is executed is added to the total interference. The total running time of GCCFG would be O([n*1]/2*n²)—>O(n³) where n is the number of function vertices, and 1 is the number of loop nodes in the GCCFG. Note that we will need to traverse the height of the graph twice to find the LCA of two given nodes.

Algorithm 4: Interference GCCFG

| | Input: A CCFG G = (V,E), M |
|---|---|
| | Output: TotalInterference |
| 1 | foreach i ε V_{f} do |
| 2 | foreach j ε V_{f}, i ≠ j [symbol] M[i] = M [j] do |
| 3 | if i := LCA(i,j) then |
| 4 | TotalInterference+ = Cost(i) + |
| | Cost(FunctionsOnPath(i,j)₁) |
| 5 | each if j := LCA(i,j) then |
| 6 | TotalInterference+ = Cost(j) + |
| | Cost(FunctionsOnPath(j,i)₁) |
| 7 | else |
| 8 | TotalInterference+ = Cost(LCA(i,j)) |

B. Interference calculation using Global CFG. Algorithm 5 shows how to determine the interference cost if we used the Global CFG. To calculate the total interference between any two functions in a program there are two main loops at lines 1 and 3. First we must cycle through every basic block in the whole program until we find one i that is a entry to or exit from a function, as this is where a swap can occur in memory. Now we need to find another block j that is an entry into a function, mapped to the same region as i, and i and j are in separate functions. At line 5 we then need to do a depth first search to find the state of the memory (active functions in memory) and compare that to the function containing i. This means we have a conflict that will increase the cost of the interference. Line 7 determines if both blocks are inside a loop, because this will increase the total cost by the number of times a loop iterates during the execution of the program. Otherwise we only add the cost of the number of times blocks i and j are executed to the total interference cost. The total running time for Algorithm 5 is O(b²*b+2L), where b is the number of basic blocks in a program, and L is the maximum number of basic blocks in a loop. b can be approximated as n*B, where n is the number of functions in the whole program and B is the maximum number of basic blocks in a function. Further, in a Global CFG, if a function is called multiple times then it is necessary to make a copy of the basic blocks for each call and inline those blocks into the graph. We can represent this inline factor as c which is a multiplication factor for how many times a function is inlined Therefore the total running time for Algorithm 5 is actually O([N*B*c]³) compared to O(n³) for Algorithm 4.

Algorithm 5: Interference Global CFG

| | Input: A GlobalCFG P = (B,E) : H = B′, E′) ⊂ P,M |
|---|---|
| | Output: TotalInterference |
| 1 | foreach i ε B do |
| 2 | if Entry(i) [symbol] Exit(i) then |
| 3 | foreach j ε B do |
| 4 | if Entry(j) |
| | [symbol] (M[H1] = M[H2] i ε B′₁ [symbol] j ε B′₂ [symbol] Hᵢ ≠ Hⱼ) then |
| 5 | MEM = {DFS(P,i)} |
| 6 | if {H1 : i ε B′₁} ≠ MEM then |
| 7 | if LoopHead(i) := LoopHead(j) then |
| 8 | TotalInterference+ = Cost(i) + Cost(j) |
| | *LoopCost |
| 9 | else |
| 10 | TotalInterference+ = Cost(i) + Cost(j) |

### Conclusion

Since coherent caches architectures will not scale for long, researchers are on the lookout for a new memory architecture that can scale for hundreds and thousands of cores. Software Managed Manycore (SMM) architectures—in which each core has only a scratch pad memory is a promising solution, since hardware are simpler, scalable and more power-efficient. However, in SMM architectures the code and data of the tasks must be explicitly managed in the software by the compiler. State-of-the-art compiler techniques for SMM architectures require inter-procedural information and analysis, and they have used GCCFG (Global Call Control Flow Graph) for that. GCCFG is a whole program representation that captures the control-flow as well as function call information in a succinct way. However, how to construct GCCFG has not been shown yet. There are several commonly occurring cases where constructing GCCFG is not so straightforward. This disclosure provides for graph transformations that allow correct construction of GCCFG in nearly all cases. Experiments show that by using succinct representation (GCCFG) rather than elaborate representation (GlobalCFG), the compilation time of state-of-the-art code management technique (Bai, et al., 2013) can be improved by an average of 5×, and that of stack management (Lu, et al., 2013) can be improved by an average of 4×.

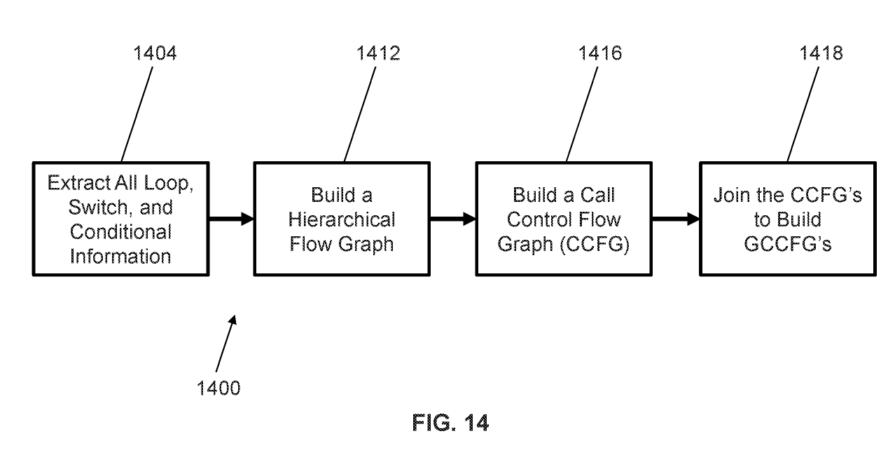

Turning now to the figures, FIG. 14 illustrates one embodiment 1400 of the present methods, comprising receiving at least one function executed by a computer program; extracting at least one loop in the computer program 1404 involving the at least one function; building a global call control flow graph 1418 based, at least in part, on the extracted at least one loop and the at least one function of the computer program, wherein the global call control flow graph represents interconnectivity in the computer program; and analyzing a code complexity of the computer program based, at least in part, on the global call control flow graph to manage data on a manycore system. In some embodiments, the step of building the global call control flow graph 1418 comprises building at least one hierarchical flow graph 1412 based on the at least one loop; building a call control flow graph 1416 based on the at least one hierarchical flow graph; and joining the at least one call control flow graph to create the global call control flow graph 1416. FIG. 10 further illustrates joining call control flow graphs where common vertices may be joined together to create a glue point for forming a global call control graph based on at least one call control flow graph.

FIG. 6 illustrates that some embodiments further comprise receiving at least one condition 616 executed by the computer program, wherein the step of building the global call control flow graph is further based, at least in part, on the received at least one condition (see, e.g., 620).

In some embodiments, the at least one loop comprises one of a poorly formed loop (see, e.g., 900a or 910a in FIGS. 9A and 9B), a switch (see, e.g., 920 in FIG. 9C), a convergence of at least two conditions, a recursive procedure (see, e.g., FIG. 5A), or an at least one function pointer. As illustrated in FIGS. 9A-9D, in some embodiments, at least one exit block 935 is added to the hierarchical flow graph. In some embodiments, at least one place holder block 922 is added to the hierarchical flow graph.

In some embodiments, at least three distinct representational units are used in building the at least one call control flow graph, the at least three distinct representational units indicating at least a function, a loop, and a condition. For example, in FIG. 6, a function place holder (FPH) 400 is mapped to a circle vertex 404, a loop place holder (LPH) 408 is mapped to a square vertex 412, and an if-then-else condition 416 is mapped to a diamond vertex 420.

In some embodiments, analyzing the code complexity comprises calculating a total interference of the computer program. And some embodiments further comprise transforming the computer program to reduce the total interference of the computer program.

One embodiment of the present computer program products, comprises a non-transitory computer readable medium comprising code for performing the steps of: receiving at least one function executed by a computer program; extracting at least one loop in the computer program involving the at least one function; building a global call control flow graph based, at least in part, on the extracted at least one loop and the at least one function of the computer program, wherein the global call control flow graph represents interconnectivity in the computer program; and analyzing a code complexity of the computer program based, at least in part, on the global call control flow graph to manage data on a manycore system. In some embodiments of the present computer program products, the step of building the global call control flow graph comprises: building at least one hierarchical flow graph based on the at least one loop; building a call control flow graph based on the at least one hierarchical flow graph; and joining the at least one call control flow graph to create the global call control flow graph. In some embodiments, the non-transitory computer readable medium further comprises code for performing the step of receiving at least one condition executed by the computer program, wherein the step of building the global call control flow graph is further based, at least in part, on the received at least one condition.

In some embodiments, at least one loop comprises one of a poorly formed loop, a switch, a convergence of at least two conditions, a recursive procedure, or an at least one function pointer. In some embodiments, an at least one exit block is added to the hierarchical flow graph. In some embodiments, an at least one place holder block is added to the hierarchical flow graph. In some embodiments, at least three distinct representational units are used in building the at least one call control flow graph, the at least three distinct representational units indicating at least a function, a loop, and a condition.

In some embodiments of the present computer program products, analyzing the code complexity comprises calculating a total interference of the computer program. In some embodiments, the non-transitory computer readable medium further comprises code for performing the step of transforming the computer program to reduce the total interference of the computer program.

Some embodiments of the present apparatuses comprise: a memory; and processor coupled to the memory, wherein the processor is configured to execute the steps of: receiving at least one function executed by a computer program; extracting at least one loop in the computer program involving the at least one function; building a global call control flow graph based, at least in part, on the extracted at least one loop and the at least one function of the computer program, wherein the global call control flow graph represents interconnectivity in the computer program; and analyzing a code complexity of the computer program based, at least in part, on the global call control flow graph to manage data on a manycore system. In some embodiments, the step of building the global call control flow graph comprises: building at least one hierarchical flow graph based on the at least one loop; building a call control flow graph based on the at least one hierarchical flow graph; and joining the at least one call control flow graph to create the global call control flow graph. In some embodiments, the processor coupled to the memory is further configured to execute the step of receiving at least one condition executed by the computer program, wherein the step of building the global call control flow graph is further based, at least in part, on the received at least one condition.

In some embodiments, the at least one loop comprises one of a poorly formed loop, a switch, a convergence of at least two conditions, a recursive procedure, or an at least one function pointer. In some embodiments, an at least one exit block is added to the hierarchical flow graph. In some embodiments, an at least one place holder block is added to the hierarchical flow graph. In some embodiments, at least three distinct representational units are used in building the at least one call control flow graph, the at least three distinct representational units indicating at least a function, a loop, and a condition.

In some embodiments, the step of analyzing the code complexity comprises calculating a total interference of the computer program. In some embodiments the processor coupled to the memory is further configured to execute the step of transforming the computer program to reduce the total interference of the computer program.

All of the methods disclosed and claimed herein can be made and executed without undue experimentation in light of the present disclosure. While the compositions and methods of this invention have been described in terms of preferred embodiments, it will be apparent to those of skill in the art that variations may be applied to the methods and in the steps or in the sequence of steps of the method described herein without departing from the concept, spirit and scope of the invention. More specifically, it will be apparent that certain agents which are both chemically and physiologically related may be substituted for the agents described herein while the same or similar results would be achieved. All such similar substitutes and modifications apparent to those skilled in the art are deemed to be within the spirit, scope and concept of the invention as defined by the appended claims.

### REFERENCES

The following references, to the extent that they provide exemplary procedural or other details supplementary to those set forth herein, are specifically incorporated herein by reference.
“A Software-Only Scheme for Managing Heap Data on Limited Local Memory (LLM) Multicore Processors,” Trans. on Embedded Computing Sys., vol. 13, no. 5, pp. 472-511, 2013.
“Automatic and Efficient Heap Data Management for Limited Local Memory Multicore Architectures,” in Proceedings of the 2013 International Conference on Design Automation and Test in Europe (DATE), 2013.
“Intel Core i7 Processor Extreme Edition and Intel Core i7 Processor Datasheet, Volume 1,” in White paper. Intel, 2010.
“Raw Performance: SiSoftware Sandra 2010 Pro (GFLOPS).”
Bai and A. Shrivastava, “Heap Data Management for Limited Local Memory (LLM) Multi-core Processors,” in Proc. of CODES+ISSS, 2010, pp. 317-326.
Bai, A. Shrivastava, and S. Kudchadker, “Stack Data Management for Limited Local Memory (LLM) Multi-core Processors,” in Proc. Of ASAP, 2011a, pp. 231-234.
Bai, D. Lu, and A. Shrivastava, “Vector Class on Limited Local Memory (LLM) Multi-core Processors,” in Proc. of CASES, 2011b, pp. 215-224.
Bai, J. Lu, A. Shrivastava, and B. Holton, “CMSM: An Efficient and Effective Code Management for Software Managed Multicores,” in Proc. of CODES+ISSS, 2013, pp. 1-9.
Baker, A. Panda, N. Ghadge, A. Kadne, and K. S. Chatha, “A Performance Model and Code Overlay Generator for Scratchpad Enhanced Embedded Processors,” in Proc. of CODES+ISSS, 2010, pp. 287-296.
Banakar, S. Steinke, B. -S. Lee, M. Balakrishnan, and P. Marwedel, “Scratchpad Memory: Design Alternative for Cache on-chip Memory in Embedded Systems,” in Proc. of CODES, 2002, pp. 73-78.
Bournoutian and A. Orailoglu, “Dynamic, Multi-core Cache Coherence Architecture for Power-sensitive Mobile Processors,” in Proc. Of CODES+ISSS, 2011, pp. 89-98.
Choi et al., “DeNovo: Rethinking the Memory Hierarchy for Disciplined Parallelism,” in Proc. of PACT, 2011, pp. 155-166.
Ferrante, K. J. Ottenstein, and J. D. Warren, “The Program Dependence Graph and its use in Optimization,” ACM TOPLAS, vol. 9, no. 3, pp. 319-349,1987.
Flachs et al., “The Microarchitecture of the Synergistic Processor for a Cell Processor,” Solid-State Circuits, IEEE Journal of, vol. 41, no. 1, pp. 63-70,2006.
Guthaus et al., “MiBench: A Free, Commercially Representative Embedded Benchmark Suite,” in Proc. of the Workload Characterization, 2001.
Heinrich et al., “A Quantitative Analysis of the Performance and Scalability of Distributed Shared Memory Cache Coherence Protocols,” IEEE Trans. Comput., vol. 48, no. 2, pp. 205-217, February 1999.
Horwitz, T. Reps, and D. Binkley, “Interprocedural Slicing using Dependence Graphs,” ACM Trans. Program. Lang. Syst., vol. 12, no. 1, pp. 26-60,1990.
Jang, J. Lee, B. Egger, and S. Ryu, “Automatic Code Overlay Generation and Partially Redundant Code Fetch Elimination,” ACM Trans. Archit. Code Optim., vol. 9, no. 2, pp. 10:1-10:32, 2012.
Jung, A. Shrivastava, and K. Bai, “Dynamic Code Mapping for Limited Local Memory Systems,” in Proc. of ASAP, 2010, pp. 13-20.
Lu, K. Bai, and A. Shrivastava, “SSDM: Smart Stack Data Management for Software Managed Multicores (SMMs),” in Proc. of DAC, 2013.
Milanova, A. Rountev, and B. G. Ryder, “Precise call graphs for c programs with function pointers,” Automated Software Engineering, vol. 11, no. 1, pp. 7-26,2004.
Polychronopoulos, “The Hierarchical Task Graph and its Use in Auto-scheduling,” in Proc. of Supercomputing, 1991, pp. 252-263.
Udayakumaran, A. Dominguez, and R. Barua, “Dynamic Allocation for Scratch-pad Memory using Compile-time Decisions,” Trans. On Embedded Computing Sys., vol. 5, no. 2, pp. 472-511,2006.
Whitham, “Optimal Program Partitioning for Predictable Performance,” in Proc. of ECRTS, 2012.
Xu, Y. Du, Y. Zhang, and J. Yang, “A Composite and Scalable Cache Coherence Protocol for Large Scale CMPs,” in Proc. of ICS, 2011, pp. 285-294.

What is claimed is:

1. A method for managing data and memory on a many core system; comprising:
receiving at least one function executed by a computer program;
extracting at least one of a loop, a conditional, or a switch in the computer program involving the at least one function;
building a global call control flow graph based, at least in part, on the extracted at least one of a loop, conditional or switch and the at least one function of the computer program, wherein the global call control flow graph represents interconnectivity in the computer program, and where the step of building a global call control flow graph comprises:
building at least one hierarchical flow graph based on the at least one loop, conditional, or switch;
building a call control flow graph based on the at least one hierarchical flow graph; and
joining the at least one call control flow graph to create the global call control flow graph.
analyzing a code complexity of the computer program based, at least in part, on the global call control flow graph.

2. The method of claim 1 where the at least one loop comprises one of a poorly formed loop, a switch, a convergence of at least two conditions, a recursive procedure, or an at least one function pointer.

3. The method of claim 1 where at least one exit block is added to the hierarchical flow graph.

4. The method of claim 1 where at least one place holder block is added to the hierarchical flow graph.

5. The method of any of claim 1 where at least three distinct representational units are used in building the at least one call control flow graph, the at least three distinct representational units indicating at least a function, a loop, and a conditional.

6. The method of claim 1 where analyzing the code complexity comprises calculating a total interference of the computer program.

7. The method of claim 6 further comprising transforming the computer program to reduce the total interference of the computer program.

8. A computer program product for managing data and memory on a many core system, comprising:
a non-transitory computer readable medium comprising code for performing the steps of:
receiving at least one function executed by a computer program;
extracting at least one of a loop, a conditional, or a switch in the computer program involving the at least one function;
building a global call control flow graph based, at least in part, on the extracted at least one loop, conditional, or switch and the at least one function of the computer program, wherein the global call control flow graph represents interconnectivity in the computer program, and where the step of building a global call control flow graph comprises:
building at least one hierarchical flow graph based on the at least one loop, conditional, or switch;
building a call control flow graph based on the at least one hierarchical flow graph;
joining the at least one call control flow graph to create the global call control flow graph; and
analyzing a code complexity of the computer program based, at least in part, on the global call control flow graph.

9. The computer program product of claim 10 where the at least one loop comprises one of a poorly formed loop, a switch, a convergence of at least two conditions, a recursive procedure, or an at least one function pointer.

10. The computer program product of claim 10 where an at least one exit block is added to the hierarchical flow graph.

11. The computer program product of claim 10 where an at least one place holder block is added to the hierarchical flow graph.

12. The computer program product of claims 10 where at least three distinct representational units are used in building the at least one call control flow graph, the at least three distinct representational units indicating at least a function, a loop, and a conditional.

13. The computer program product of claim 10 where analyzing the code complexity comprises calculating a total interference of the computer program.

14. The computer program product of claim 13 where the non-transitory computer readable medium further comprises code for performing the step of transforming the computer program to reduce the total interference of the computer program.

15. An apparatus, comprising:
a memory; and
a processor coupled to the memory, wherein the processor is configured to execute the steps of:
receiving at least one function executed by a computer program;
extracting at least one a loop, a conditional, or a switch in the computer program involving the at least one function;
building a global call control flow graph based, at least in part, on the extracted at least one loop, conditional, or switch and the at least one function of the computer program, wherein the global call control flow graph represents interconnectivity in the computer program, and where the step of building a global call control flow graph comprises:
building at least one hierarchical flow graph based on the at least one loop, conditional, or switch;
building a call control flow graph based on the at least one hierarchical flow graph; and
joining the at least one call control flow graph to create the global call control flow graph.; and
analyzing a code complexity of the computer program based, at least in part, on the global call control flow graph.

16. The apparatus of claim 15 where the at least one loop comprises one of a poorly formed loop, a switch, a convergence of at least two conditions, a recursive procedure, or an at least one function pointer.

17. The apparatus of claim 15 where an at least one exit block is added to the hierarchical flow graph.

18. The apparatus of claim 15 where an at least one place holder block is added to the hierarchical flow graph.

19. The apparatus of claim 15 where at least three distinct representational units are used in building the at least one call control flow graph, the at least three distinct representational units indicating at least a function, a loop, and a conditional.

20. The apparatus of claim 15, wherein the step of analyzing the code complexity comprises calculating a total interference of the computer program.

21. The apparatus of claim 20, wherein the processor coupled to the memory is further configured to execute the step of transforming the computer program to reduce the total interference of the computer program.
